(19) United States
(12) Patent Application Publication
(10) Pub. No.: US 2018/0354040 A1
(43) Pub. Date: Dec. 13, 2018

(54) ADAPTOR WITH QUICK RELEASE MECHANISM

(71) Applicant: NN, Inc., Johnson City, TN (US)

(72) Inventors: Matthew Cohn, Orange, CT (US); Aaron Mathew Bailey, Round Rock, TX (US); James M. Walsh, Naperville, IL (US); Rick Fu, Quincy, MA (US); Kevin Kolka, Waterford, CT (US); John Kollar, Fairfield, CT (US)

(21) Appl. No.: 16/006,446

(22) Filed: Jun. 12, 2018

Related U.S. Application Data
(60) Provisional application No. 62/518,687, filed on Jun. 13, 2017.

(51) Int. Cl. B23B 31/08

(52) U.S. Cl. CPC B23B 31/086; B23B 2260/008; B23B 2231/14; B23B 2231/04

(57) ABSTRACT

A quick-release adaptor for a tool for a torque limiter is provided. The quick-release adaptor has a housing having a first opening at a first end and a second opening at a second end. The first opening engages a drive shaft of the torque limiter to axially and rotationally connect the drive shaft to the housing. The second opening receives the tool. A groove is provided on an exterior of the housing between the first end and the second end. At least one through hole extends through the groove and into an interior of the housing. A ball bearing is seated within the through hole. A spring clamp is provided in the groove and extends over the ball bearing to exert a radially inward force on the ball bearing to seat the tool.

### CROSS-REFERENCE TO RELATED APPLICATIONS

This application claims the benefit of U.S. Provisional Patent Application No. 62/518,687, filed Jun. 13, 2017, which is expressly incorporated herein by reference and made a part hereof.

### FEDERALLY SPONSORED RESEARCH OR DEVELOPMENT

Not Applicable.

### TECHNICAL FIELD

The present invention relates generally to an adaptor for a tool, and more specifically to an adaptor that has a quick release mechanism for receiving a variety of tools and which can be secured to a torque limiting mechanism.

### SUMMARY

According to one embodiment, the disclosed subject technology relates to an adaptor for a torque limiter assembly to allow a plurality of different tools to be used with the same torque limiter.

The disclosed subject technology further relates to a quick-release adaptor for a tool for a torque limiter, comprising: a housing having a first opening at a first end, a second opening at a second end, the first opening engaging a drive shaft of the torque limiter assembly, the drive shaft being axially and rotationally connect to the housing; a plurality of fingers at the second end of the housing to assist in receiving the tool; a groove on an exterior of the housing between the first end and the second end; first and second through holes extending through the groove and into an interior of the housing; first and second ball bearings seated within the first and second through holes, respectively; and, a clamp in the groove and extending over the ball bearings to exert a radially inward force on the ball bearings.

The disclosed subject technology further relates to a quick-release adaptor for a tool for a torque limiter, the tool having a radial groove in an exterior thereof, the quick-release adaptor comprising: a housing having a first opening at a first end, a second opening at a second end, the first opening engaging a drive shaft of the torque limiter, the drive shaft being axially and rotationally connect to the housing, the second opening receiving the tool; a groove on an exterior of the housing between the first end and the second end; at least one through hole extending through the groove and into an interior of the housing; a ball bearing seated within the through hole; and, a spring clamp in the groove and extending over the ball bearing to exert a radially inward force on the ball bearing.

The disclosed subject technology further relates to a quick-release adaptor for a tool for a torque limiter, comprising: a housing having a first opening at a first end, a second opening at a second end, the first opening engaging a drive shaft of the torque limiter assembly, the second opening receiving the tool, and the drive shaft being axially and rotationally connect to the housing; a groove on an exterior of the housing between the first end and the second end; at least one through hole extending through the groove and into an interior of the housing; a ball bearing seated within each of the at least one through hole; a spring clamp in the groove and extending over the ball bearing to exert a radially inward force on the ball bearings; and, a plurality of fingers at the second end of the housing, the fingers assisting in receiving the tool and leading the tool into the second opening of the housing.

The disclosed subject technology further relates to a quick-release adaptor wherein the drive shaft has a plurality of tabs, and wherein the housing has a plurality of receivers to engage the tabs to seat the housing on the drive shaft. In one embodiment the tabs each have a radially extending flange.

The disclosed subject technology further relates to a quick-release adaptor, wherein the receivers comprise flexible fingers to engage the tabs and retain the drive shaft in a snap-fit manner.

The disclosed subject technology further relates to a quick-release adaptor wherein the drive shaft has first and second opposed tabs. In one embodiment, first and second flexible fingers engage the first and second opposed tabs, respectively, in a snap-fit manner.

The disclosed subject technology further relates to a quick-release adaptor, wherein the drive shaft has an opening and a receiver therein, the receiver in the opening shaped to mate with a drive end of the tool to rotationally fix the tool to the drive shaft.

The disclosed subject technology further relates to a quick-release adaptor, wherein the second opening of the housing has a receiver shaped to mate with a drive end of the tool to rotationally fix the tool to the adaptor.

The disclosed subject technology further relates to a quick-release adaptor, wherein the through holes have a first diameter adjacent an exterior of the housing, and a second diameter adjacent the interior of the housing, the first diameter being larger than the second diameter.

The disclosed subject technology further relates to a quick-release adaptor, wherein the tool has a radial groove in an exterior thereof to seat the ball bearings to axially retain the tool in the adaptor.

The disclosed subject technology further relates to a quick-release adaptor, wherein the clamp is a c-clamp, and further comprising a protrusion in the groove to assist in locating the c-clamp in the groove.

The disclosed subject technology further relates to a quick-release adaptor, wherein the drive shaft has an opening and a receiver therein, the receiver in the opening shaped to mate with a drive end of the tool to rotationally fix the tool to the drive shaft.

The disclosed subject technology further relates to a quick-release adaptor, further comprising a divider wall between the first opening and the second opening, the divider wall having an opening therein to join the first and second openings.

It is understood that other embodiments and configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

To understand the present invention, it will now be described by way of example, with reference to the accompanying drawings in which:

FIG. 1 is a front perspective view of one embodiment of an adaptor connected to a torque limiter.

FIG. 2 is an exploded view of the adaptor and torque limiter of FIG. 1.

FIG. 3 is a cross-sectional view of the drive shaft and adaptor about line 3-3 of FIG. 1.

FIG. 4 is a cross-sectional view of the adaptor about line 4-4 of FIG. 1.

FIG. 5 is a cross-sectional view of the drive shaft and adaptor about line 5-5 of FIG. 1.

FIG. 6 is a rear perspective view with a partial cut-away of the adaptor of FIG. 1.

FIG. 7A is a view showing one embodiment of an adaptor before insertion of one embodiment of a tool.

FIG. 7B is a view showing the adaptor of FIG. 7A during insertion of the tool.

FIG. 7C is a view showing the adaptor of FIG. 7A following complete insertion of the tool.

FIG. 8 is a front perspective view of another embodiment of an adaptor secured to another embodiment of a torque limiter.

FIG. 9 is a cross-sectional view of the drive shaft of the torque limiter of FIG. 8 and the adaptor of FIG. 8 about line 9-9 of FIG. 8.

FIG. 10 is a cross-sectional view of the adaptor about line 10-10 of FIG. 8.

FIG. 11 is a cross-sectional view of the drive shaft and adaptor about line 11-11 of FIG. 8.

FIG. 12 is an exploded view of the drive shaft and adaptor of FIG. 8.

FIG. 13 is a rear perspective view with a partial cut-away of the adaptor of FIG. 8.

FIG. 14 is a front perspective view of another embodiment of an adaptor secured to another embodiment of a torque limiter.

FIG. 15 is an exploded view of the torque limiter, drive shaft, adaptor and tool of FIG. 14.

FIG. 16 is a rear exploded view of the drive shaft and adaptor of FIG. 14.

FIG. 17 is a rear perspective view with a partial cut-away of the adaptor of FIG. 14.

FIG. 18 is a cross-sectional view of the adaptor of FIG. 14 before insertion of one embodiment of a tool.

FIG. 19 is a cross-sectional view showing the adaptor of FIG. 18 following complete insertion of the tool.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

Referring now to the Figures, there is shown a variety of embodiments of an adaptor assembly that may be utilized in combination with a torque limiter assembly. The torque limiter assembly assists in limiting the amount of torque applied to a fastener by a tool receiving input from the torque limiter. Preferably, the maximum amount of torque the torque limiter is able to apply is preset during assembly of the torque limiter. The torque limiter tool can be virtually any type of hand-held or power-driven device that is used to apply torque to a driven member, e.g., a fastener, but in a preferred embodiment the torque limiter tool is a hand-held torque wrench. Additionally, the adaptor assembly may be made to connect to a variety of different types of torque limiters and to accept a variety of different types of tools to engage/manipulate a variety of types of fasteners. In this specification like reference numerals, or like reference numerals in a different series (e.g., 00 series, 100 series, 200 series, etc.), designate like components throughout the disclosure.

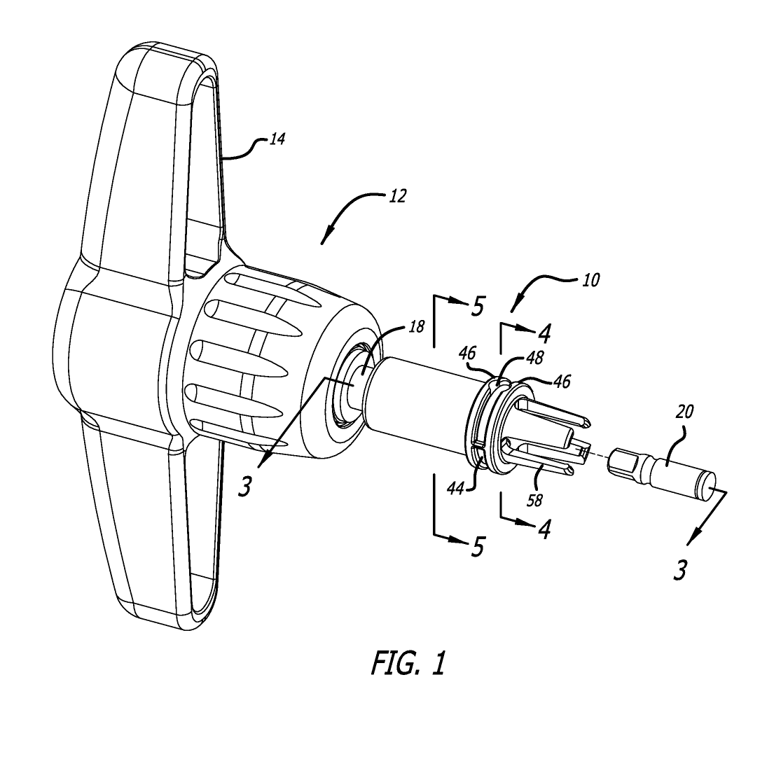

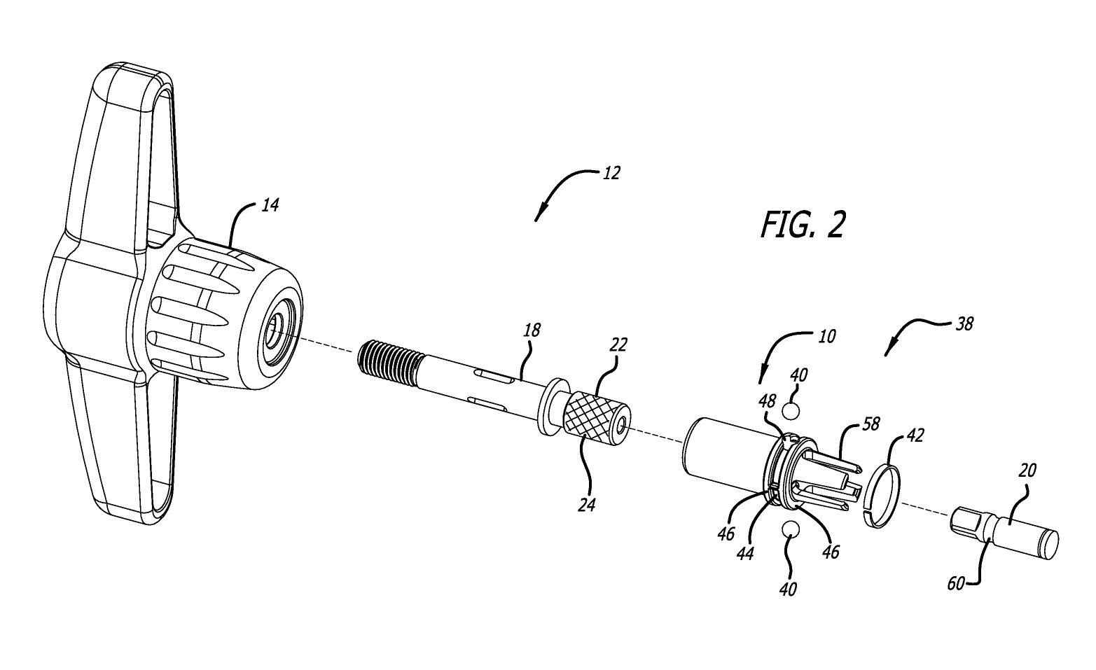

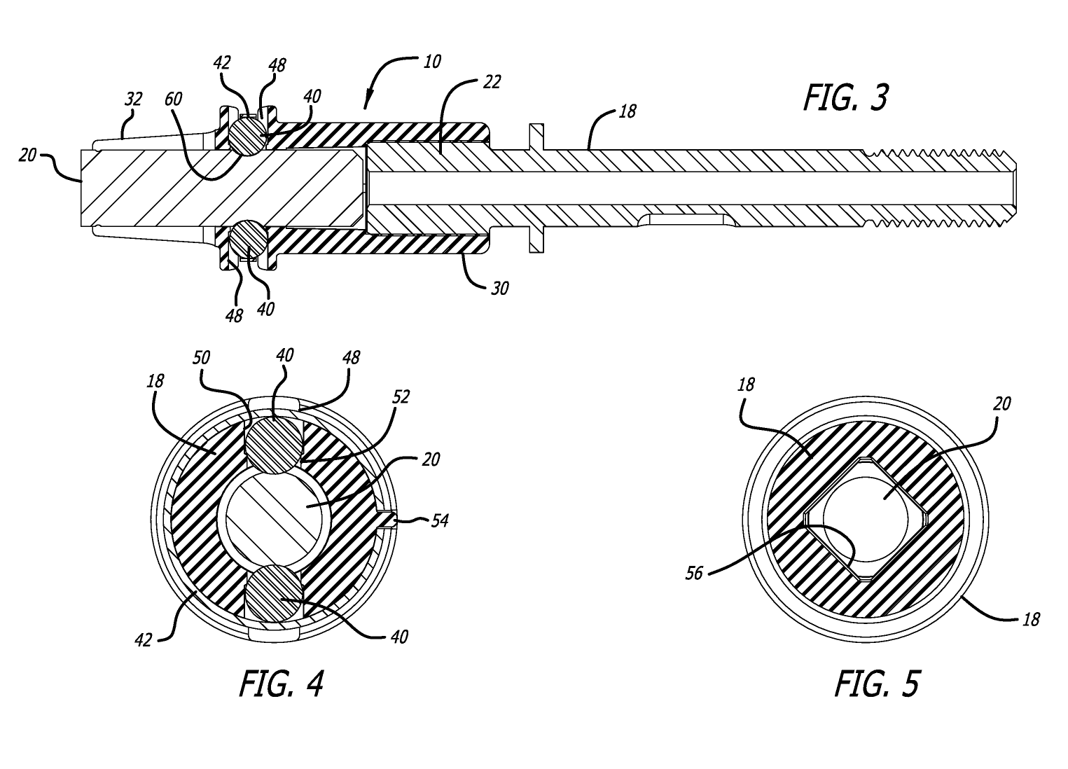

Various embodiments of the adaptor 10, 110, 210 and torque limiter 12, 112, 212 are shown in FIGS. 1-7, 8-13 and 14-19. As shown in FIGS. 1 and 2, in one embodiment the torque limiter 12 generally comprises a housing 14, a torque limiting mechanism 16 within the housing 14, and a drive shaft 18 extending out of the housing 14. The adaptor 10 is connected to the drive shaft 18 of the torque limiter assembly 12. The adaptor 10 is provided to allow a single torque limiter 12 to be connectable to a variety of different tools 20. In one embodiment, such as shown in FIGS. 1 and 2, the output torque of the torque limiter is generally provided to the shaft 18 via its connection to the housing 14, which is generally turned by the user or to which torque is applied via a separate drive mechanism.

As shown in FIGS. 1 and 2, rather than having the output end 22 of the drive shaft 18 directly engage a fastener, such as, for example, a screw to be inserted into an implant, an adaptor 10 is secured to the output end 22 of the drive shaft 18. The adaptor 10 is able to receive a variety of different tools 20 that are used to engage the fastener for manipulating the fastener. Accordingly, because the adaptor 10 can accept a variety of different tools 20, the same single torque limiter 12 having an adaptor 10 that can accept a variety of different tools 20 can be used with numerous different types of fasteners, instead of just one type of fastener.

In one embodiment the output end 22 of the drive shaft 18 has a knurled surface 24 and the adaptor 10 is pressure fit onto the knurled surface 24 of the drive shaft 18. Alternately, the adaptor 10 may be secured through other means to the output end 22 of the drive shaft 18. For example, the adaptor 10 may be threaded to the drive shaft 18. Additional mating methods may be employed to secure the adaptor 10 to the drive shaft 18.

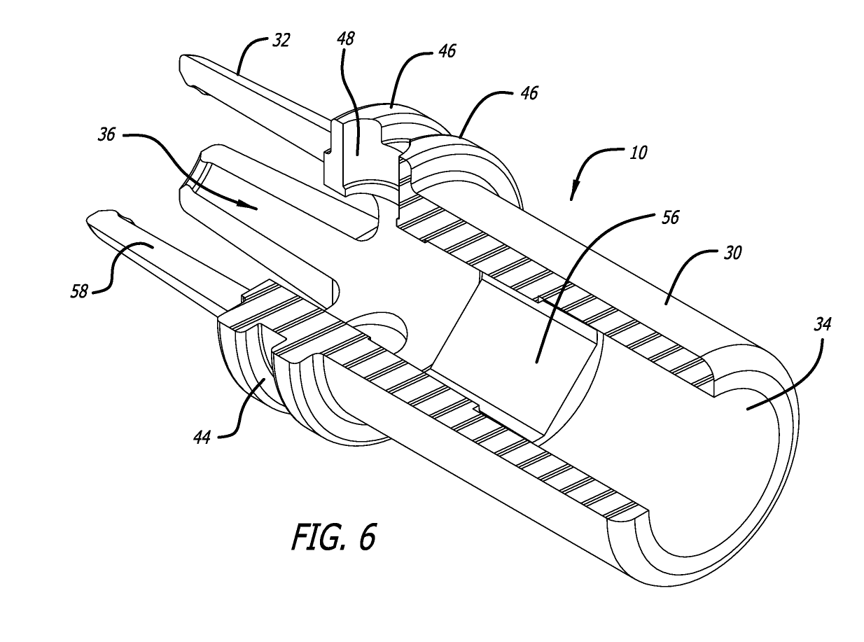

As shown in FIG. 6, the adaptor 10 has a first end 30 that operatively mates with the output end 22 of the drive shaft 18, and a second end 32 that operatively receives the tool 20. In one embodiment, the first end 30 of the adaptor 10 has a first opening 34 to receive and secure, in a press fit manner, the output end 22 of the drive shaft 18. The second end 32 of the adaptor 10 has a second opening 36 to receive and secure therein the tool 20.

Referring to FIGS. 2-4, 6 and 7, the adaptor 10 also has a locking mechanism 38. In a preferred embodiment, the locking mechanism 38 comprises at least one, but preferably two or more ball bearings 40 and a locking clamp 42. The locking mechanism 38 may be retained in a groove 44 in the adaptor 10. In one embodiment ribs 46 are provided on each side of the groove 44. Through holes 48 are also provided in the groove 44, and extend from the outer surface of the adaptor 10 to the second opening 36 of the adaptor 10. In a preferred embodiment, the through holes 48 have varied diameters when extending from the outer surface of the adaptor 10 to the second opening 36, as shown in FIG. 4. For example, the first inner diameter 50 of the through holes 48 adjacent the outer surface of the adaptor 10 is as large, or larger, than the diameter of the ball bearings 40, however, the second inner diameter 52 of the through holes 48 adjacent the second opening 36 is less than the diameter of the ball bearings 40 so that the ball bearings 40 cannot fall into the second opening 36 of the adaptor 10. In a preferred embodiment the locking clamp 42 comprises a spring clamp or C-clamp that extends around the ball bearings 40 in the groove 44. In one embodiment the groove 44 around the adaptor 10 is not continuous, as shown in FIG. 4, due to a protrusion 54 extending within the groove 44. The protrusion 54 may be provided to help seat the locking clamp 42 within the groove 44. By having the clamp 42 extend over the ball bearings 40 in the groove 44 the ball bearings 40 are forced into the through holes 48 to engage the tool 20 as the tool 20 is inserted into the second opening 36 in the adaptor 10.

As best shown in FIGS. 2 and 6, inside the second opening 36 the adaptor 10 has a receiver 56 for receiving a drive end of the tool 20. The shape of the receiver 56 is preferably shaped to transmit torque from the torque limiter assembly 12, through the adaptor 10, and to the tool 20 for rotating a fastener. In the embodiment of FIGS. 1-7, the drive end of the tool 20 has a square cross-sectional shape. Accordingly, as shown in FIGS. 5 and 6, the receiver 56 has a mating square cross-sectional shape to mate with the square cross-sectional shape of the drive end of the tool 20.

In one embodiment, the second end 32 of the adaptor 10 also has a plurality of fingers 58 which may be able to flex to assist in receiving and securing the tool 20 within the second opening 36 of the adaptor 10.

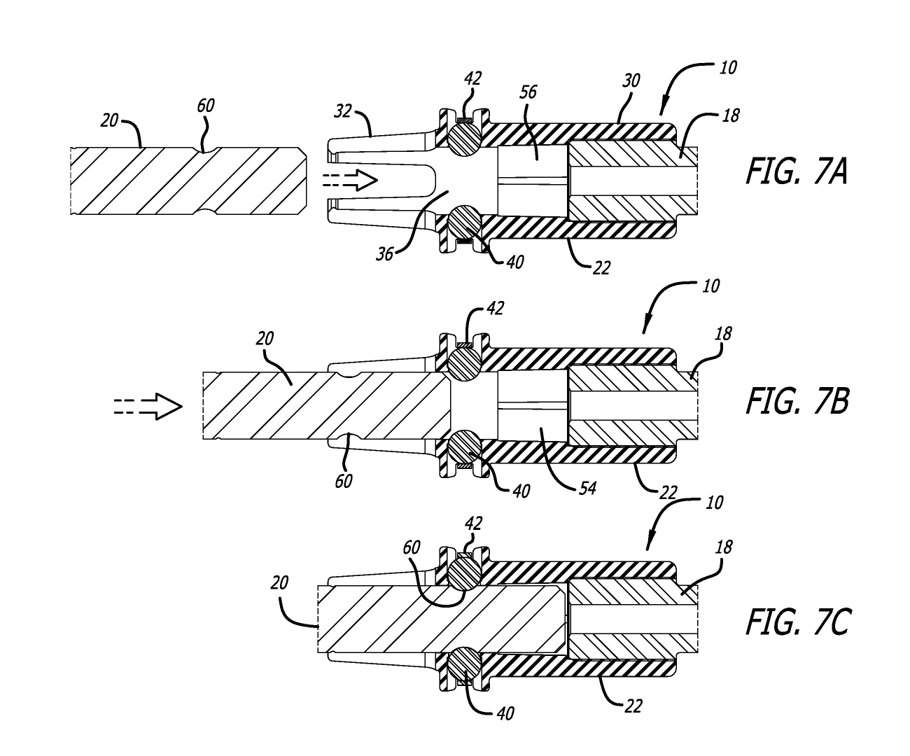

To secure a tool 20 to the adaptor 10, as shown in FIGS. 7A-7C, an end of the tool 20 is first fitted into the second opening 36 of the adaptor 10. Prior to insertion of the tool 20, as shown in FIG. 7A, the clamp 42 extends over the ball bearings 40 in the groove 44, and since there is no other opposing force on the ball bearings 40 the ball bearings 40 will be fully seated within the through holes 48 and against the smaller second inner diameter 52.

As shown in FIGS. 1 and 2, the tool 20 also preferably has a groove 60 which is used to mate with the ball bearings 40 of the adaptor. Accordingly, as shown in FIG. 7B, as the tool 20 is fitted within the second opening 36 of the adaptor 10 the outer surface of the tool 20 will have a larger circumference than the opening within the second opening 36 due to the ball bearings 40 extending into the second opening 36 through the through holes 48. Thus, the outer surface of the tool 20 will exert a force on the ball bearings 40 to push the ball bearings 40 outwardly through the through holes 48 and against the spring clamp 42.

To fully seat the tool 20, the tool 20 is continued to be pushed into the second opening 36 of the adaptor 10 until two things occur. First, the drive end of the tool 20 will engage the receiver 56 within the second opening 36 of the adaptor 10. Because of the specific geometry of the drive end of the tool 20, the user may have to rotate the tool 20 to properly mate the drive end of the tool 20 with mating geometry of the receiver 56. The user will continue to push the tool 20 further into the second opening 36 of the receiver 20 until the groove 60 of the tool 20 mates with the ball bearings 40 of the adaptor 10. At that point, the spring force of the spring clamp 42 will force the ball bearings 40 into the groove 60 of the tool 20 and the tool will be fully seated within the second opening 36 of the adaptor 10 as shown in FIG. 7C. By having the ball bearings 40 within the groove 60 of the tool 20, the tool 20 is generally retained within the second opening 36 and generally cannot move axially within the second opening 36, including the tool will generally not be able to be unintentionally removed from the second opening 36 without applying a sufficient removal force on the tool 20 to overcome the spring force on the ball bearings 40 within the groove 60 of the tool 20. Because the drive end of the tool 20 mates with the receiver 56 of the adaptor 10, when the torque limiter 12 (with the adaptor 10 connected thereto) is rotated, the tool 20 will rotate therewith the torque limiter 12 to transmit torque to an associated fastener.

The adaptor 10 can theoretically be used with any torque limiter 12. The only requirement for use is that the adaptor 10 has a first end 30 that operatively mates with the output end 22 of the drive shaft 18 of the torque limiter 12.

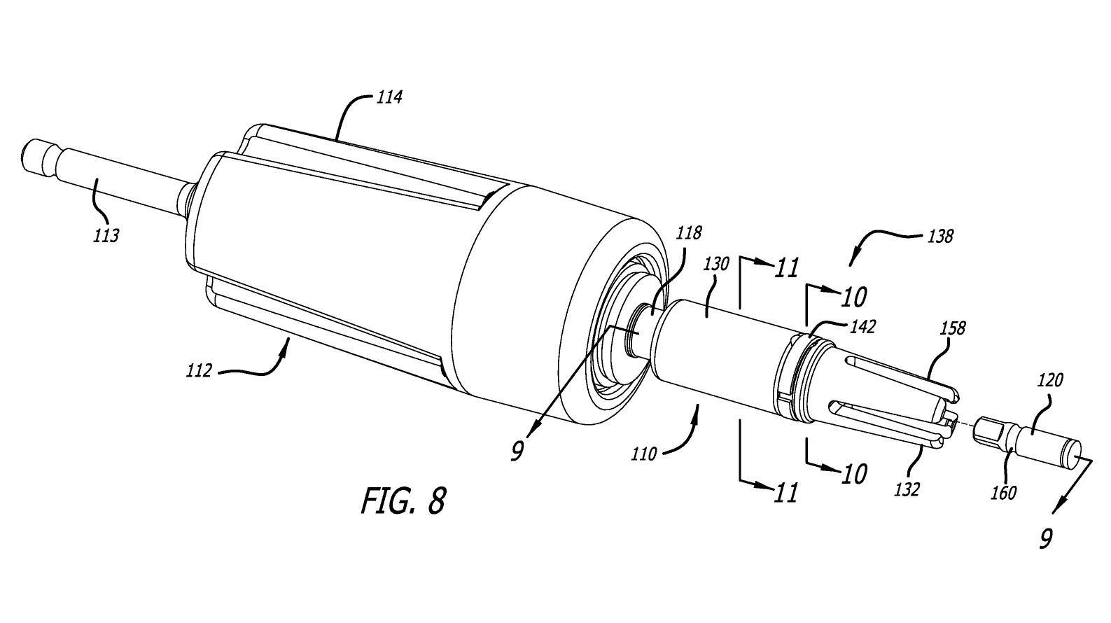

Another embodiment of an adaptor 110 is shown in FIGS. 8-13. In this embodiment the adaptor 110 is connected to a torque limiter 112 having a drive shaft 118 that has a square cross-sectional shaped output end 122 (instead of the knurled surface 24 of the prior drive shaft 18). While two different shapes and mating configurations of output ends of drive shafts and first ends of adaptors are shown, it is clear that generally any type of mating connection that is able to transmit torque from the drive shaft to the input opening of the adaptor will be acceptable. Additionally, the torque limiter 112 of this embodiment has an input shaft 113 to receive torque input from an alternate source, such as a powered source.

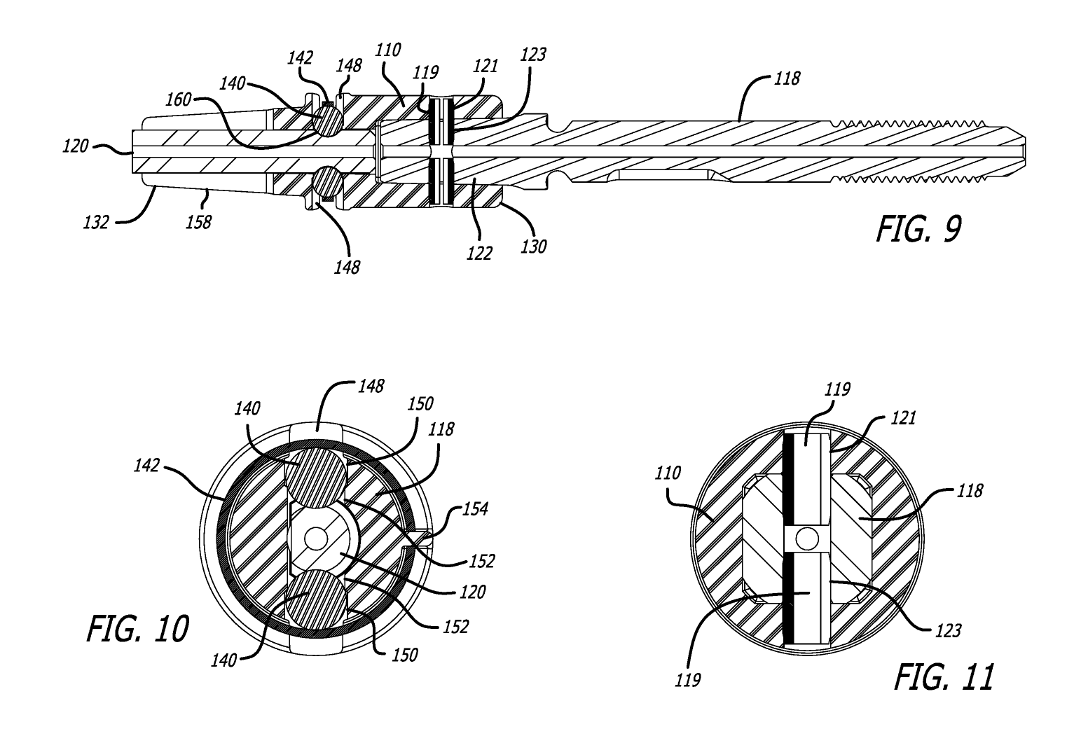

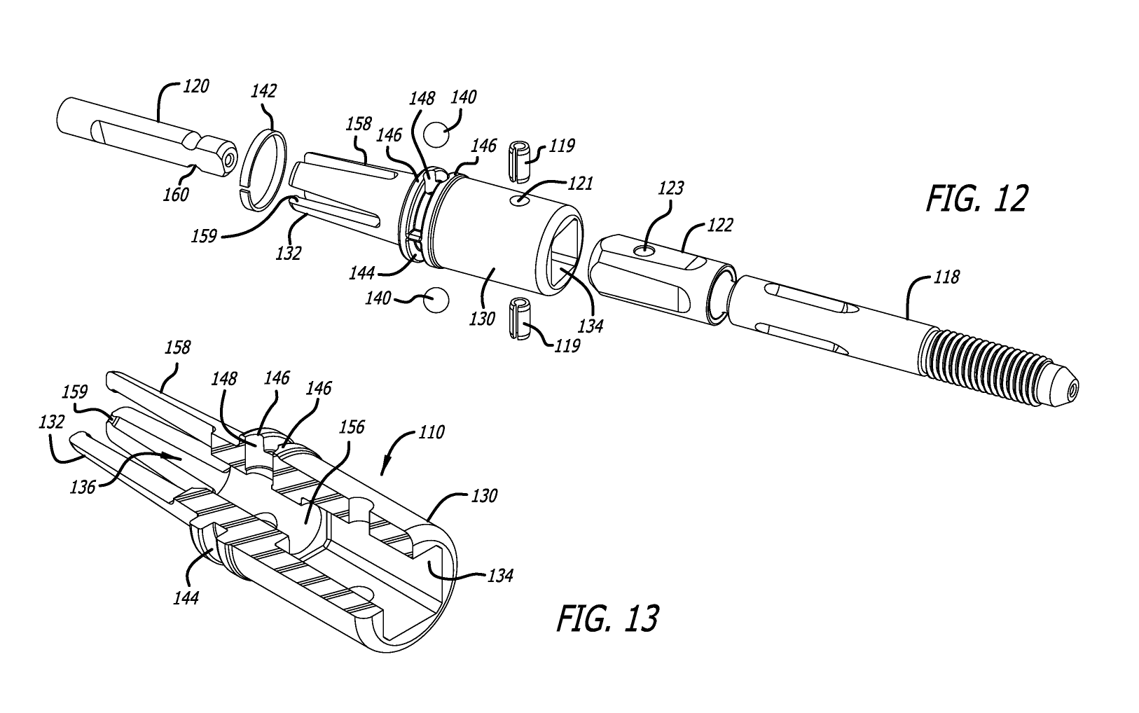

Referring to FIGS. 9 and 12, the adaptor 110 of this embodiment has a first end 130 that operatively mates with the output end 122 of the drive shaft 118, and a second end 132 that operatively receives the tool 120. In this exemplar embodiment, the output end 122 of the drive shaft 118 has a generally square cross-sectional male shape. Accordingly, in this exemplar embodiment, the first end 130 of the adaptor 110 has a first opening 134 that has a mating square cross-sectional female receiver shape to receive and secure the output end 122 of the drive shaft 118. In this embodiment, the drive shaft 118 is further secured to the adaptor 110 with the use of pins 119. Specifically, the adaptor 110 has openings 121 that mate with openings 123 in the drive shaft 118 so that after the drive shaft 118 is inserted into the first opening 134 of the adaptor 110, the pins 119 can be inserted, as best shown in FIGS. 9, 11 and 12 into both the openings 121 in the adaptor 110 and the openings 123 in the drive shaft 118 to mechanically fix the adaptor 110 to the drive shaft 118.

Referring to FIGS. 9-10 and 12-13, the adaptor 110 of this embodiment also has a locking mechanism 138. In a preferred embodiment, the locking mechanism 138 of this mechanism is identical to the locking mechanism 38 of the first embodiment of the adaptor 10. Specifically, the locking mechanism 138 comprises at least one, but preferably two or more ball bearings 140 and a locking clamp 142. The locking mechanism 138 may be retained in a groove 144 in the adaptor 110. Further, ribs 146 may be provided on each side of the groove 144. Through holes 148 are also provided in the groove 144, and extend from the outer surface of the adaptor 110 to the second opening 136. In a preferred embodiment, the through holes 148 have varied diameters when extending from the outer surface of the adaptor 110 to the second opening 136, as shown in FIG. 10. For example, the first inner diameter 150 of the through holes 148 adjacent the outer surface of the adaptor 110 is as large, or larger, than the diameter of the ball bearings 140, however, the second inner diameter 152 of the through holes 148 adjacent the second opening 136 is less than the diameter of the ball bearings 140 so that the ball bearings 140 cannot fall into the second opening 136 of the adaptor 110. In a preferred embodiment the locking clamp 142 comprises a spring clamp or C-clamp that extends around the ball bearings 140 in the groove 144. In a preferred embodiment the groove 144 around the adaptor 110 is not continuous, as shown in FIG. 10, due to a protrusion 154 extending within the groove 144. The protrusion 154 may be provided to help seat the locking clamp 142 within the groove 144. By having the clamp 142 extend over the ball bearings 140 in the groove 144, the ball bearings 140 are forced into the through holes 148 to engage the tool 120 as the tool 120 is inserted into the second opening 136 in the adaptor 110.

As best shown in FIGS. 12 and 13, the inside of the second opening 136 of the adaptor 110 has a receiver 156 for receiving a drive end of the tool 120. The shape of the receiver 156 is preferably shaped to transmit torque from the torque limiter assembly 112, through the adaptor 110, and to the tool 120 for rotating a fastener. In the embodiment of FIGS. 8-13, the drive end of the tool 120 has a D-shaped cross-sectional shape as best shown in FIG. 12, which is essentially a round circumference with a flat. Accordingly, as shown in FIG. 10, the receiver 156 has a mating D-shaped cross-sectional shape to mate with the D-shaped cross-sectional shape of the drive end of the tool 120.

Similar to the earlier embodiment, the second end 132 of the adaptor 110 of this embodiment also has a plurality of fingers 158 which may be able to flex to assist in receiving and securing the tool 120 within the second opening 136 of the adaptor 110. Additionally, the fingers 158 may have a nub 159 at the end thereof to engage the groove in the tool for assistance during insertion and removal of the tool 120 from the adaptor 110.

To secure a tool 120 to the adaptor 110 of this embodiment, the drive end of the tool 120 is first fitted into the second opening 136 of the adaptor 110. Prior to insertion of the tool 120 the clamp 142 extends over the ball bearings 140 in the groove 144, and since there is no other opposing force on the ball bearings 140, the ball bearings 140 will be fully seated within the through holes 148 and against the smaller second inner diameter 152.

As shown in FIGS. 26-28, the tool 120, like the prior tool 20, also preferably has a groove 160 which is used to mate with the ball bearings 140 of the adaptor 110. Accordingly, as the tool 120 is fitted within the second opening 136 of the adaptor 110 the outer surface of the tool 120 will have a larger circumference than the opening within the second opening 136 due to the ball bearings 140 extending into the second opening 136 through the through holes 148. Thus, the outer surface of the tool 120 will exert a force on the ball bearings 140 to push the ball bearings 140 outwardly through the through holes 148 and against the spring clamp 142.

To fully seat the tool 120 within the adaptor 110, the tool 120 is continued to be pushed into the second opening 136 of the adaptor 110 until two things occur. First, the drive end of the tool 120 will engage the receiver 156 within the second opening 136 of the adaptor 110. Because of the specific geometry of the drive end of the tool 120, the user may have to rotate the tool 120 to properly mate the drive end of the tool 120 with mating geometry of the receiver 156. Once the tool is properly mated with the receiver, the user will continue to push the tool 120 further into the second opening 136 and into the receiver 120 until the groove 160 of the tool 120 mates with the ball bearings 140 of the adaptor 110. At that point, the spring force of the spring clamp 142 will force the ball bearings 140 into the groove 160 of the tool 120 in a snap-fit manner and the tool will be fully seated within the second opening 136 of the adaptor 110. By having the ball bearings 140 within the groove 160 of the tool 120, the tool 120 is generally retained within the second opening 136 and generally will not move axially within the second opening 136, including it will generally not be able to be unintentionally removed from the second opening 136 without applying a sufficient removal force on the tool 120 to overcome the spring force on the ball bearings 140 within the groove 160 of the tool 120. Because the drive end of the tool 120 mates with the receiver 156 of the adaptor 110, when the torque limiter 112 (with the adaptor 110 connected thereto) is rotated, the tool 120 will rotate therewith the torque limiter 112 to transmit torque to an associated fastener.

The adaptor 110 can be used in theory with any torque limiter 112. The only requirement for use is that the adaptor 110 has a first end 130 that operatively mates with the output end 122 of the drive shaft 118 of the torque limiter 112. Further, by having a quick release adapter a variety of different tools may be utilized with the same torque limiter.

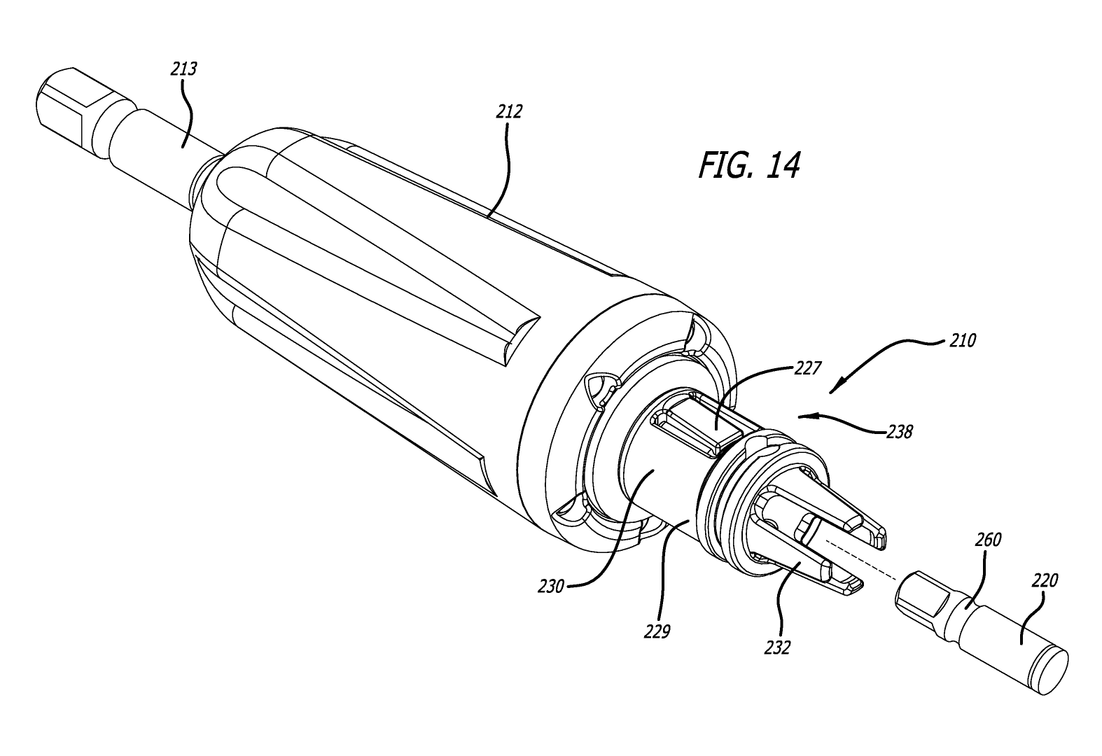

Another embodiment of an adaptor 210 is shown in FIGS. 14-19. In this embodiment the adaptor 210 is connected to a torque limiter 212 having an input shaft 213 to receive torque input from an alternate source, such as a powered source, and an output or drive shaft 218 that has an output end 222 to engage the adaptor 210.

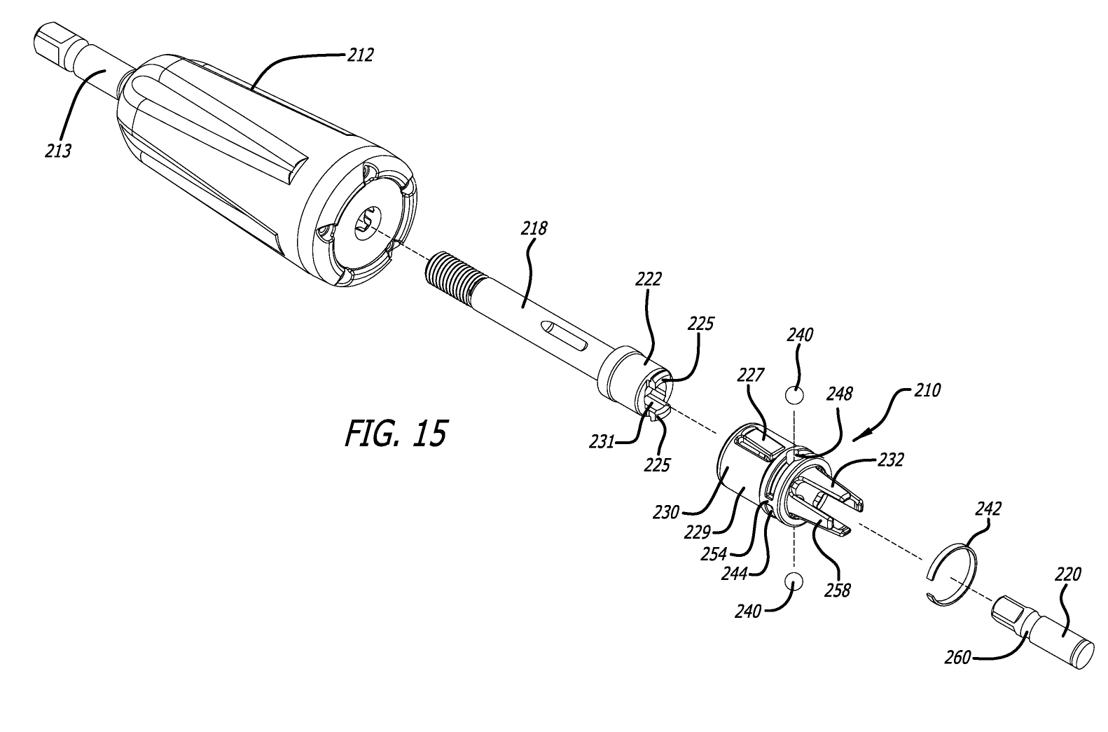

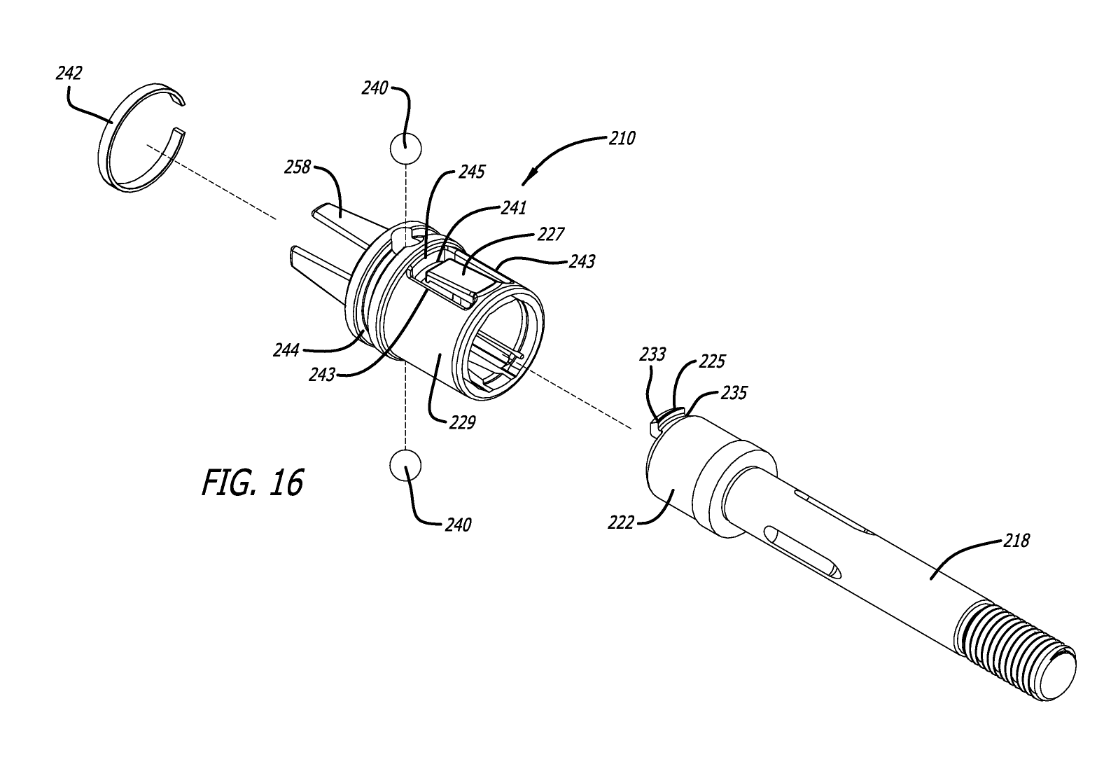

In this embodiment the output end 222 of the drive shaft 218 has a pair of tabs 225, instead of the knurled surface 24 of drive shaft 18 of the first embodiment (see FIG. 2) or the square cross-sectional shaped output end 122 of the drive shaft 118 of the second embodiment (see FIGS. 8 and 12). As explained herein, and as shown in FIGS. 16-19, the tabs 225 engage receivers 227 of the adaptor housing or adaptor body 229 of the adaptor 210 to secure the adaptor 210 to the drive shaft 218 of the torque limiter 212. Additionally, the output end 222 of the drive shaft 218 of this embodiment also has an opening 231, as shown in FIGS. 15, 18 and 19, to receive the drive tool 220 and rotatedly couple the drive tool 220 to the drive shaft 218.

Referring to FIGS. 15-17, the adaptor housing 229 of the adaptor 210 of this embodiment has a first end 230 that operatively mates with the output end 222 of the drive shaft 218, and a second end 232 that operatively receives the drive tool 220. As explained above, in this exemplar embodiment, the output end 222 of the drive shaft 218 has a plurality of tabs 225 to engage the adaptor body 229. In a preferred embodiment the adaptor 210 has two opposed tabs 225. In one embodiment, the tabs 225 have a radially extending flange 233 and an undercut 235 to engage and secure the receivers 227 of the adaptor body 229.

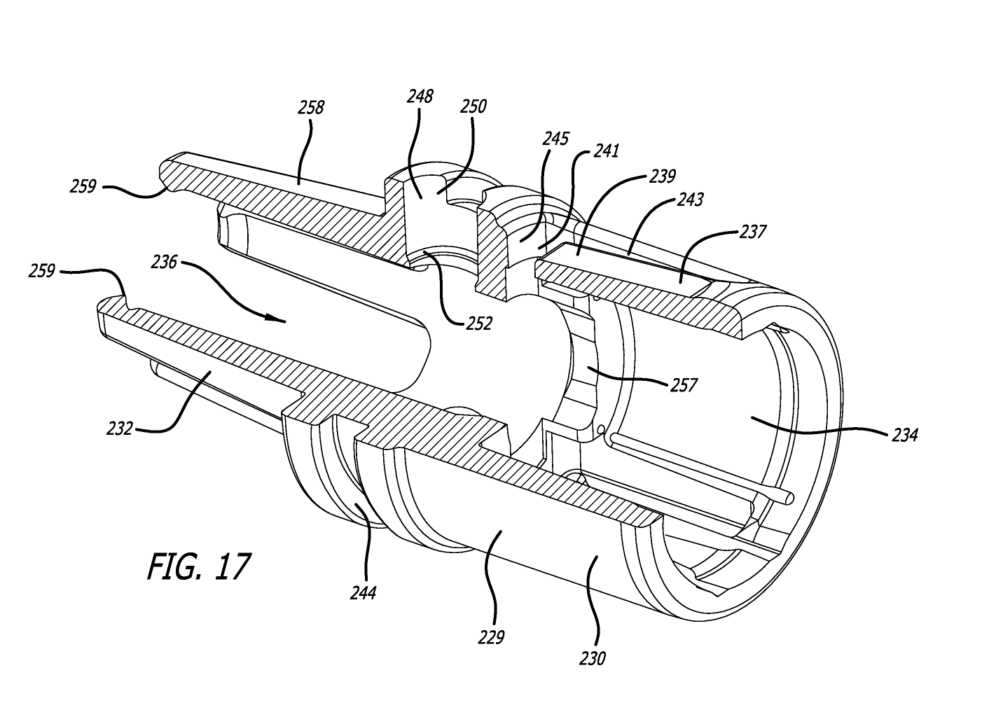

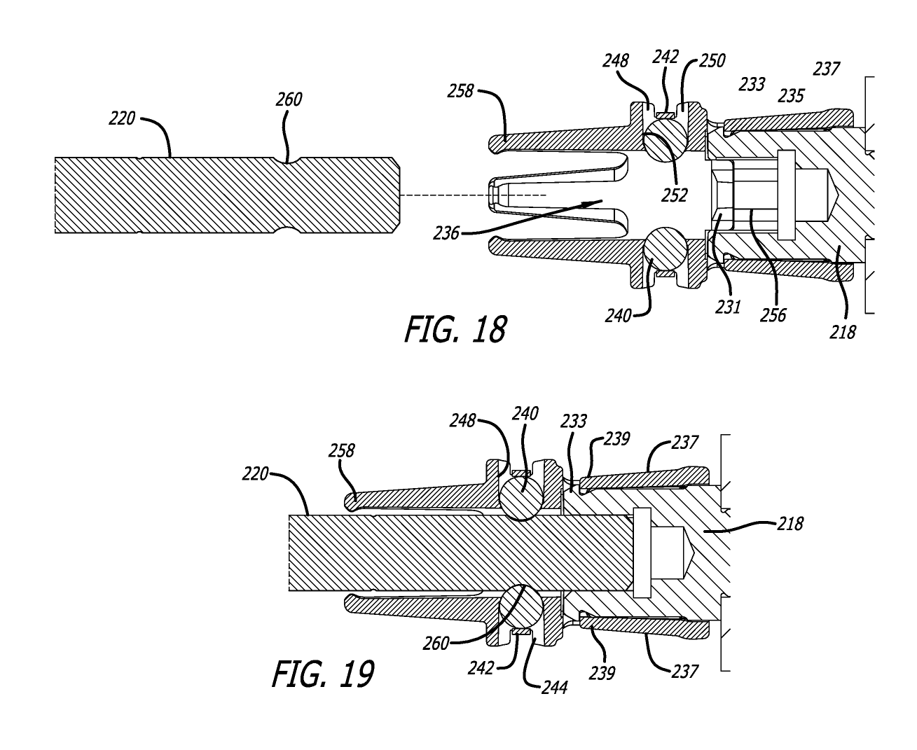

Referring to FIGS. 16-19, the receivers 227 of the adaptor body 229 may comprise flexible fingers 237. In one embodiment, the fingers 237 have protrusions, not shown, to engage the undercut 235. In a preferred embodiment, as shown in FIGS. 17-19, the end 239 of the fingers 237 engage the radially extending flange 233 adjacent the undercut 235 to secure the adaptor body 229 to the drive shaft 218. The adaptor body 229 has openings 241 adjacent the fingers 237 to allow the tabs 225 of the drive shaft 218 to pass through so that the end 239 of the fingers 237 can engage the radially extending flange 233 of the tabs 225. The openings 241 have sidewalls 243 and an end wall 245. Preferably, the fingers 237 are flexible and are angled radially inwardly as shown in FIGS. 16 and 17. When the output end 222 of the drive shaft 218 is inserted axially into the first opening 234 of the adaptor body 229, the radially extending flanges 233, respectively, flex the fingers 237 radially outwardly until the flanges 233 move past the end 239 of the fingers 237. When the radially extending flanges 233 move sufficiently into the adaptor body 229 to be past the end 239 of the fingers 237, the flexible fingers 237 will snap radially inwardly and engage the radially extending flanges 233 adjacent the undercut 235 thereof as shown in FIGS. 18 and 19 to secure the adaptor body 229 to the drive shaft 218. In this position the fingers 237 axially prevent the adaptor body 229 from being removed axially from the drive shaft 218. Further, the sidewalls 243 of the openings 241 prevent rotational movement of the adaptor body 229 with respect to the drive shaft 218, and the end wall 245 prevents the drive shaft 218 from further axial movement into the first opening 234 of the adaptor body 229. This essentially mechanically fixes the adaptor 210 to the drive shaft 218 of the torque limiter.

As shown in FIGS. 15 and 18-19, and as described above, the output end 222 of the drive shaft 218 of this embodiment has an opening 231 with a receiver 256 to receive the drive end of a drive tool 220 and rotatedly couple the drive tool 220 to the drive shaft 218. The shape of the receiver 256 is preferably shaped to transmit torque from the torque limiter assembly 212 directly to the tool 220 for rotating a fastener. In one embodiment, the drive end of the tool 220 has a generally square-shaped cross-sectional shape as best shown in FIGS. 14 and 15. Accordingly, as shown in FIGS. 15 and 18-19, the receiver 256 has a mating square-shaped cross-sectional shape to mate with the square-shaped cross-sectional shape of the drive end of the tool 220. However, a variety of shapes for the receiver 256 may be provided to mate with the appropriate shape of the drive end of the tool 220.

Referring to FIGS. 14-16 and 18-19, the adaptor 210 of this embodiment also has a locking mechanism 238. In a preferred embodiment, the locking mechanism 238 of this mechanism is identical to the locking mechanisms 38, 123 of the previously described embodiments of the adaptor 10, 110. Preferably, the locking mechanism 238 comprises at least one, but preferably two or more ball bearings 240 and a locking clamp 242. The locking mechanism 238 may be retained in a groove 244 in the adaptor 210. Further, ribs 246 may be provided on each side of the groove 244. Thru holes 248 are also provided in the groove 244, and extend from the outer surface of the adaptor body 229 to the second opening 236 of the adaptor body 229. In a preferred embodiment, the through holes 248 have varied diameters when extending from the outer surface of the adaptor body 229 to the second opening 236, as shown in FIGS. 18 and 19. In one embodiment, the first inner diameter 250 of the through holes 248 adjacent the outer surface of the adaptor body 229 is as large, or larger, than the diameter of the ball bearings 240, however, the inner diameter 252 of the through holes 248 adjacent the second opening 236 is less than the diameter of the ball bearings 240 so that the ball bearings 240 cannot fall into the second opening 236 of the adaptor 210.

In a preferred embodiment the locking clamp 242 of the locking mechanism 238 comprises a spring clamp or C-clamp that extends around the ball bearings 240 in the groove 244. In a preferred embodiment the groove 244 around the adaptor body 229 is not continuous, as shown in FIG. 15, due to a protrusion 254 extending from the groove 244. The protrusion 254 may be provided to help seat the locking clamp 242 within the groove 244. By having the clamp 242 extend over the ball bearings 240 in the groove 244, the ball bearings 240 are forced into the through holes 248 to engage the tool 220 as the tool 220 is inserted into the second opening 236 in the adaptor housing 229.

As best shown in FIGS. 17-19, between the second opening 236 of the adaptor housing 229 and the first opening 234 of the adaptor housing 229 there is a receiver 257 for receiving a drive end of the tool 220. In one embodiment the receiver 257 is an opening in a divider wall. The shape of the opening of the receiver 257 is preferably similarly shaped to the shape of the drive end of the tool 220 to allow the drive end of the tool 220 to pass through the receiver and into the second opening 234 so that the drive end of the tool 220 can mate with the receiver 256 in the opening 231 of the drive shaft 218 of the torque limiter assembly 212. Thus, the drive shaft 218 of the torque limiter assembly 212 is able to transmit torque from the torque limiter assembly 212 to the tool 220 for rotating a fastener. Alternately, the receiver 257 in the second opening 236 of the adaptor housing 229 may have any shape that allows the drive end of the tool 220 to pass thereby and into the receiver 256 in the opening 231 of the drive shaft 218.

Similar to the earlier embodiments, the second end 232 of the adaptor housing 229 of this embodiment also has a plurality of fingers 258 which may be able to flex to assist in receiving and/or securing the tool 220 within the second opening 236 of the adaptor 210. Additionally, the fingers 258 may have a nub 259 at the end thereof to engage the groove in the tool for assistance during insertion and removal of the tool 220 from the adaptor 210.

To secure a tool 220 to the adaptor 210 of this embodiment, the drive end of the tool 220 is first fitted into the second opening 236 of the adaptor 210 as shown in FIG. 18. Prior to insertion of the tool 220 the clamp 242 extends over the ball bearings 240 in the groove 244, and since there is no other opposing force on the ball bearings 240, the ball bearings 240 will be fully seated within the through holes 248 and against the smaller second inner diameter 252.

As shown in FIGS. 14-15 and 18-19, the tool 220 preferably has a groove 260 which is used to mate with the ball bearings 240 of the adaptor 210. Accordingly, as the tool 220 is fitted within the second opening 236 of the adaptor 210 the outer surface of the tool 220 will have a larger circumference than the opening within the second opening 236 due to the ball bearings 240 extending into the second opening 236 through the through holes 248. Thus, the outer surface of the tool 220 will exert a force on the ball bearings 240 to push the ball bearings 240 outwardly through the through holes 248 and against the spring clamp 242.

To fully seat the tool 220 within the adaptor 210, the tool 220 is continued to be pushed into the first opening 234 of the adaptor housing 229 and into the receiver 256 in the opening 231 of the drive shaft 218 of the torque limiter assembly 212 as shown in FIG. 19. At that point two things occur. First, the drive end of the tool 220 will engage the receiver 256 within the opening 231 of the drive shaft 218. Because of the specific geometry of the drive end of the tool 220, the user may have to rotate the tool 220 to properly mate the drive end of the tool 220 with mating geometry of the receiver 256 of the drive shaft 218. Once the tool is properly mated with the receiver 256, the user will continue to push the tool 220 further into the opening 231 and into the receiver 256 until the groove 260 of the tool 220 mates with the ball bearings 240 of the adaptor 210. At that point, as shown in FIG. 19, the spring force of the spring clamp 242 will force the ball bearings 240 into the groove 260 of the tool 220 in a snap-fit manner and the tool will be fully seated within the receiver 256 of the drive shaft 218. By having the ball bearings 240 within the groove 260 of the tool 220, the tool 220 is generally axially retained within the adaptor 210, and also within the receiver 256 of the drive shaft 218, and generally will not move axially within the adaptor 210, including it will generally not be able to be unintentionally removed from the adaptor 210 without applying a sufficient removal force on the tool 220 to overcome the spring force on the ball bearings 240 within the groove 260 of the tool 220. Because the drive end of the tool 220 mates with the receiver 256 of the drive shaft 218, when the torque limiter 212 (with the adaptor 210 connected thereto) is rotated, the tool 220 will rotate therewith the torque limiter 212 to transmit torque to an associated fastener.

As explained above, the adaptor 210 can be generally be used with any torque limiter 212. The only requirement for use is that the adaptor 210 has a first end 230 that operatively mates with the output end 2122 of the drive shaft 218 of the torque limiter 212. Further, by having a quick release adapter a variety of different tools may be utilized with the same torque limiter.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number.

It will be understood that the disclosed technology may be embodied in other specific forms without departing from the spirit or central characteristics thereof. The present examples and embodiments, therefore, are to be considered in all respects as illustrative and not restrictive, and the disclosed technology is not to be limited to the details given herein. Accordingly, while the specific embodiments have been illustrated and described, numerous modifications come to mind without significantly departing from the spirit of the disclosed technology and the scope of protection is only limited by the scope of the accompanying Claims.

What is claimed is:

1. A quick-release adaptor for a tool for a torque limiter, comprising:
a housing having a first opening at a first end, a second opening at a second end, the first opening engaging a drive shaft of the torque limiter assembly, the drive shaft being axially and rotationally connect to the housing;
a plurality of fingers at the second end of the housing to assist in receiving the tool;
a groove on an exterior of the housing between the first end and the second end;
first and second through holes extending through the groove and into an interior of the housing;
first and second ball bearings seated within the first and second through holes, respectively; and
a clamp in the groove and extending over the ball bearings to exert a radially inward force on the ball bearings.

2. The quick-release adaptor of claim 1, wherein the drive shaft has a plurality of tabs, and wherein the housing has a plurality of receivers to engage the tabs to seat the housing on the drive shaft.

3. The quick-release adaptor of claim 2, wherein the tabs each have a radially extending flange.

4. The quick-release adaptor of claim 3, wherein the receivers comprise flexible fingers to engage the tabs and retain the drive shaft in a snap-fit manner.

5. The quick-release adaptor of claim 1, wherein the drive shaft has an opening and a receiver therein, the receiver in the opening shaped to mate with a drive end of the tool to rotationally fix the tool to the drive shaft.

6. The quick-release adaptor of claim 1, wherein the second opening of the housing has a receiver shaped to mate with a drive end of the tool to rotationally fix the tool to the adaptor.

7. The quick-release adaptor of claim 1, wherein the through holes have a first diameter adjacent an exterior of the housing, and a second diameter adjacent the interior of the housing, the first diameter being larger than the second diameter.

8. The quick-release adaptor of claim 1, wherein the tool has a radial groove in an exterior thereof to seat the ball bearings to axially retain the tool in the adaptor.

9. The quick-release adaptor of claim 1, wherein the clamp is a c-clamp, and further comprising a protrusion in the groove to assist in locating the c-clamp in the groove.

10. A quick-release adaptor for a tool for a torque limiter, the tool having a radial groove in an exterior thereof, the quick-release adaptor comprising:
a housing having a first opening at a first end, a second opening at a second end, the first opening engaging a drive shaft of the torque limiter, the drive shaft being axially and rotationally connect to the housing, the second opening receiving the tool;
a groove on an exterior of the housing between the first end and the second end;
at least one through hole extending through the groove and into an interior of the housing;
a ball bearing seated within the through hole; and
a spring clamp in the groove and extending over the ball bearing to exert a radially inward force on the ball bearing.

11. The quick-release adaptor of claim 10, wherein the tool is rotationally secured to the drive shaft of the torque limiter assembly.

12. The quick-release adaptor of claim 10, wherein the tool is rotationally secured to the housing.

13. The quick-release adaptor of claim 10, wherein the drive shaft has first and second opposed tabs, each tab having a radially extending flange.

14. The quick-release adaptor of claim 13, further comprising first and second flexible fingers to engage the first and second opposed tabs, respectively, in a snap-fit manner.

15. The quick-release adaptor of claim 10, wherein the drive shaft has an opening and a receiver therein, the receiver in the opening shaped to mate with a drive end of the tool to rotationally fix the tool to the drive shaft.

16. The quick-release adaptor of claim 10, wherein the drive shaft has an opening and a receiver therein, the receiver in the opening shaped to mate with a drive end of the tool to rotationally fix the tool to the drive shaft.

17. The quick-release adaptor of claim 10, wherein the second opening of the housing has a receiver shaped to mate with a drive end of the tool to rotationally fix the tool to the adaptor.

18. A quick-release adaptor for a tool for a torque limiter, comprising:
a housing having a first opening at a first end, a second opening at a second end, the first opening engaging a drive shaft of the torque limiter assembly, the second opening receiving the tool, and the drive shaft being axially and rotationally connect to the housing;
a groove on an exterior of the housing between the first end and the second end;
at least one through hole extending through the groove and into an interior of the housing;
a ball bearing seated within each of the at least one through hole;
a spring clamp in the groove and extending over the ball bearing to exert a radially inward force on the ball bearings; and,
a plurality of fingers at the second end of the housing, the fingers assisting in receiving the tool and leading the tool into the second opening of the housing.

19. The quick-release adaptor of claim 18, further comprising a divider wall between the first opening and the second opening, the divider wall having an opening therein to join the first and second openings.

20. The quick-release adaptor of claim 18, wherein the drive shaft has first and second opposed tabs, each tab having a radially extending flange, and wherein the housing has first and second flexible fingers to engage the first and second opposed tabs, respectively, in a snap-fit manner.
